(19) United States
(12) Patent Application Publication
(10) Pub. No.: US 2026/0135945 A1
(43) Pub. Date: May 14, 2026

(54) PRE-ANSWER CALLER INTENT PREVIEW SYSTEMS AND METHODS

(71) Applicants: AT&T Intellectual Property I, L.P., Atlanta, GA (US); AT&T Technical Services Company, Inc., Vienna, VA (US)

(72) Inventors: Michael Gonzales, Austin, TX (US); Yupeng Jia, South Pasadena, CA (US); Joseph Soryal, Glendale, NY (US); Daniel Vivanco, Ashburn, VA (US); Ari Craine, Marietta, GA (US); Adrianne Binh Luu, Atlanta, GA (US); Robert Moton, JR., Alpharetta, GA (US); Robert Koch, Norcross, GA (US)

(73) Assignees: AT&T Intellectual Property I, L.P., Atlanta, GA (US); AT&T Technical Services Company, Inc., Vienna, VA (US)

(21) Appl. No.: 18/942,921

(22) Filed: Nov. 11, 2024

(51) Int. Cl. H04M 3/436

(52) U.S. Cl. CPC H04M 3/4365; H04M 2203/10; H04M 2203/558

(57) ABSTRACT

Aspects of the subject disclosure may include, for example, receiving, a call attempt from a caller to a call recipient, determining that the call recipient is a trusted party to the caller by checking a record of the call recipient in a caller intent preview database structured to store caller related data, receiving sensor data describing conditions related to the caller and surroundings of the caller, and presenting a data stream between the caller and the call recipient that comprises a preview of an intent of the caller to the call recipient before the call is completed. The preview of the intent of the caller includes prediction information indicative of urgency of the call attempt from the caller. Other embodiments are disclosed.

### FIELD OF THE DISCLOSURE

The subject disclosure relates to pre-answer caller intent preview systems and methods.

### BACKGROUND

A call recipient may not be adequately informed of an intent of a call from a caller before the call recipient decides whether or not to answer the call. It is desirable to allow the call recipient to have sufficient information describing a predicted intent of the caller, which helps the call recipient to decide to answer the call.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of a user device and sensor registration stage in accordance with various aspects described herein.

FIG. 2C is a block diagram illustrating an example, non-limiting embodiment of a user relationship registration stage in accordance with various aspects described herein.

FIG. 2D illustrates an example, non-limiting embodiment of pre-answer caller intent prediction in accordance with various aspects described herein.

FIG. 2E illustrates another example, non-limiting embodiment of pre-answer caller intent prediction in accordance with various aspects described herein.

FIG. 2F illustrates an example, non-limiting embodiment of providing supplementary data in accordance with various aspects described herein.

FIG. 2G depicts an illustrative embodiment of a method in accordance with various aspects described herein.

FIG. 2H depicts an illustrative embodiment of another method in accordance with various aspects described herein.

FIG. 2I depicts an illustrative embodiment of yet another method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for pre-answer caller intent preview systems and methods. The pre-answer caller intent preview systems and methods facilitate providing caller intent preview to a call recipient who has been registered as a trusted user before answering a call by the call recipient. The call intent preview includes information about the caller or surroundings of the caller, such as emergency situations, urgent situations, normal situations, etc. A predicted context of the call may be developed based on sensor data generated by onboard sensors of the caller's device and/or sensors in the vicinity of the caller so as to provide a prediction of the intent of the caller to the call recipient. The call intent preview also provides a video preview of the caller and the caller's surroundings to the call recipient before connecting a call between the caller and the call recipient. After the call is answered by the call recipient, a data stream including the video preview is continued and additionally, an audio message and/or supplementary data can be presented to the call recipient. Other embodiments are described in the subject disclosure.

One or more aspects of the subject disclosure are directed to a device, comprising a processing system including a processor and a memory that stores executable instructions that, when executed by the processing system, facilitate performance of operations. The operations include storing data relating to a first user in a caller intent preview database and storing data relating to one or more sensors arranged to sense surroundings of the first user. The data relating to the first user include a user identifier (ID), an ID of a first user device, a location of the first user device, the one or more sensors that are active, and second user information in a trusted user field. The operations further include detecting, using a caller intent preview application running on the first user device, a call placed by the first user directed to a second user, wherein the first user is a caller and the second user is a call recipient; receiving sensor data indicating first user conditions and the surroundings of the first user, using onboard sensors of the first user device, the one or more sensors or both; and presenting, to the second user, via a second user device, caller intent prediction information based on the sensor data, wherein the caller intent prediction information represents the first user conditions, the surroundings of the first user or both.

One or more aspects of the subject disclosure are directed to a machine-readable medium, comprising executable instructions that, when executed by a processing system including a processor, facilitate performance of operations. The operations include maintaining a caller intent preview database structured to store a plurality of user data including first user data, wherein the first user data include data identifying a first user device and location thereof, a second user ID as trusted user data, and one or more active sensors operating in a range that reaches a first user; receiving, from a caller intent preview application running on the first user device, a call detection directed to a second user; upon checking the second user stored as the trusted user data, receiving sensor data indicative of a first user state and an environment of the first user, using onboard sensors of the first user device, the one or more active sensors, or both; and generating caller intent preview at least based on the received sensor data.

One or more aspects of the subject disclosure are directed to a method including receiving, by a processing system of a network node including a processor, a call attempt from a caller to a call recipient; determining, by the processing system, that the call recipient is a trusted party to the caller by checking a record of the call recipient in a caller intent preview database structured to store caller related data; receiving, by the processing system, sensor data describing conditions related to the caller and surroundings of the caller; and presenting, by the processing system, a data stream between the caller and the call recipient that comprises a preview of an intent of the caller to the call recipient before the call is completed, wherein the preview of the intent of the caller includes prediction information indicative of urgency of the call attempt from the caller.

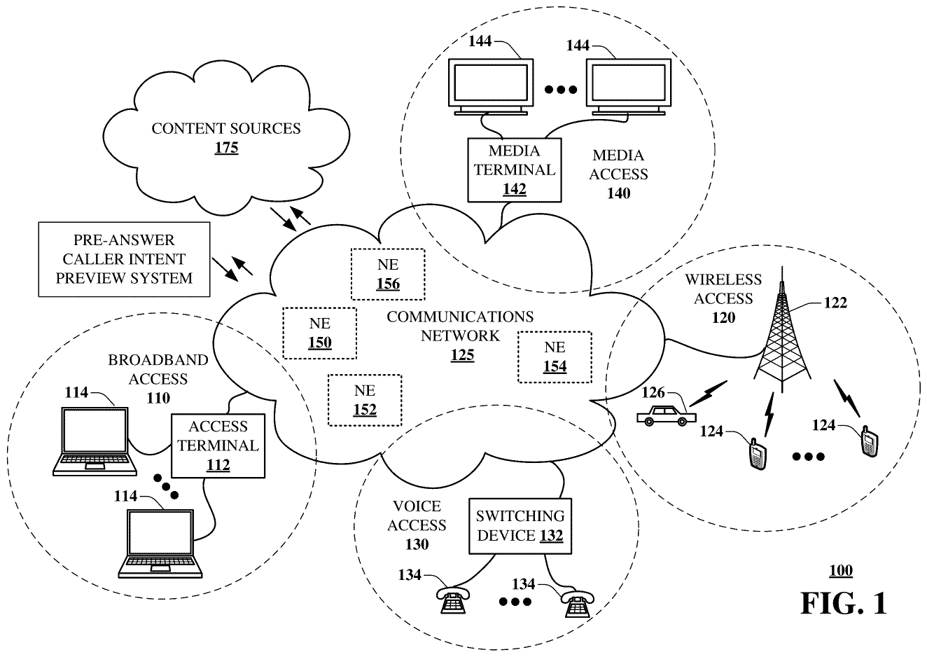

Referring now to FIG. 1, a block diagram is shown illustrating an example, non-limiting embodiment of a system 100 in accordance with various aspects described herein. For example, system 100 can facilitate in whole or in part pre-answer caller intent preview systems and methods. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

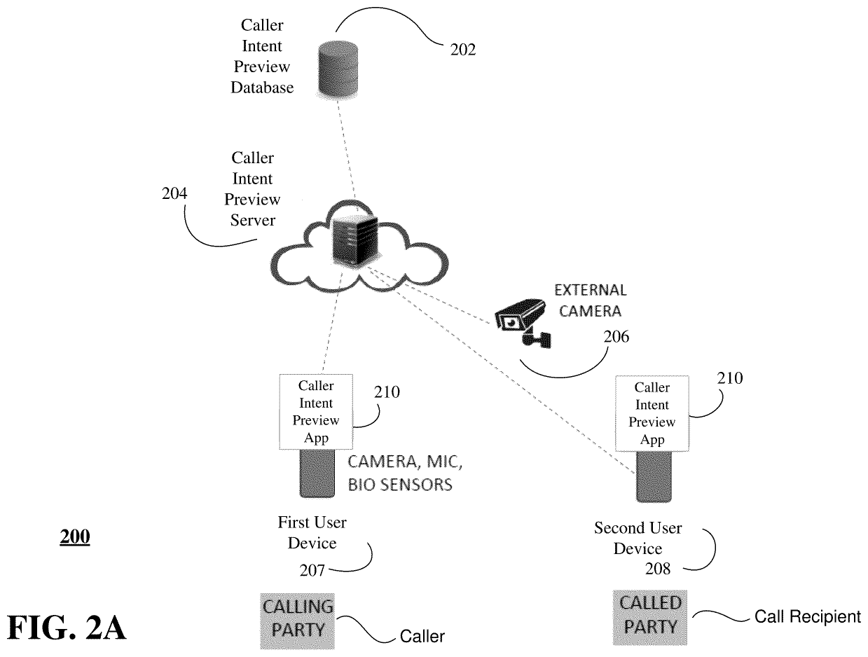

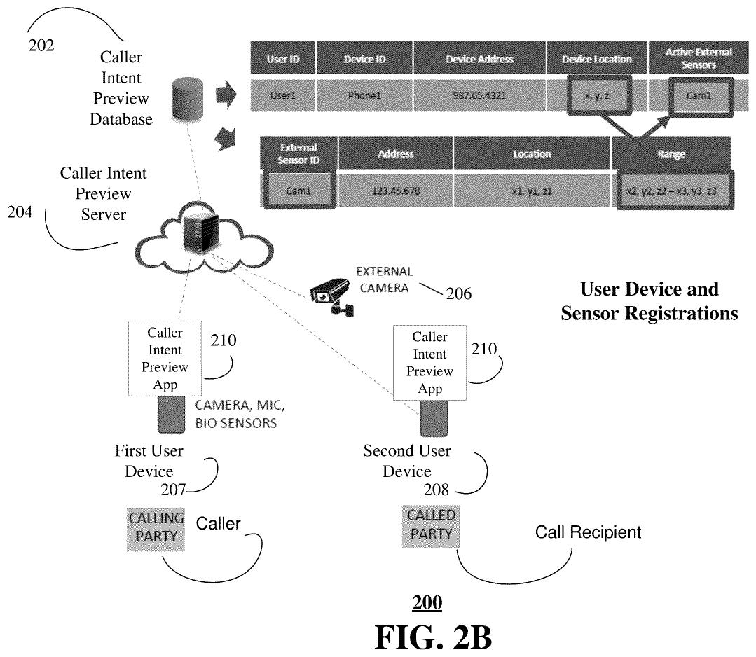

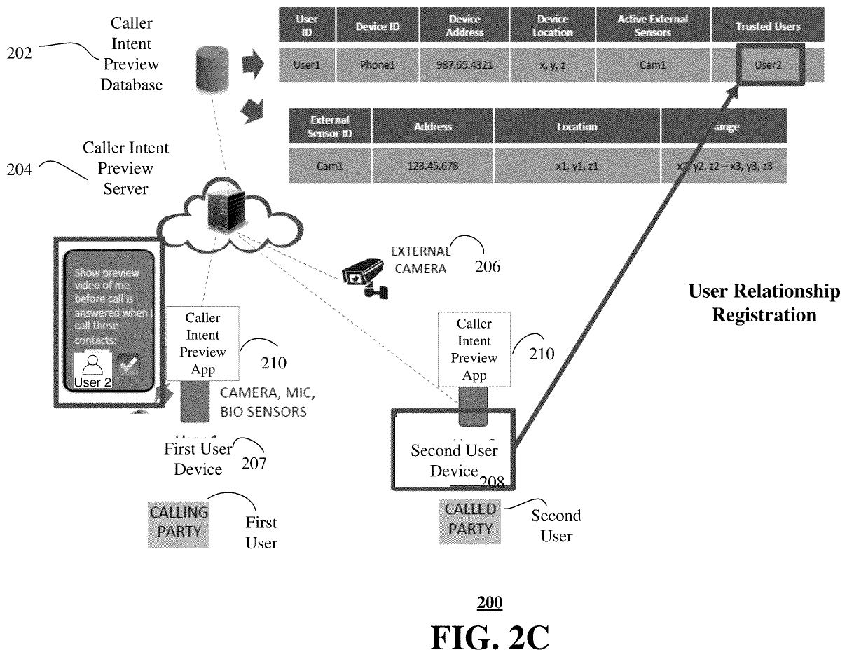

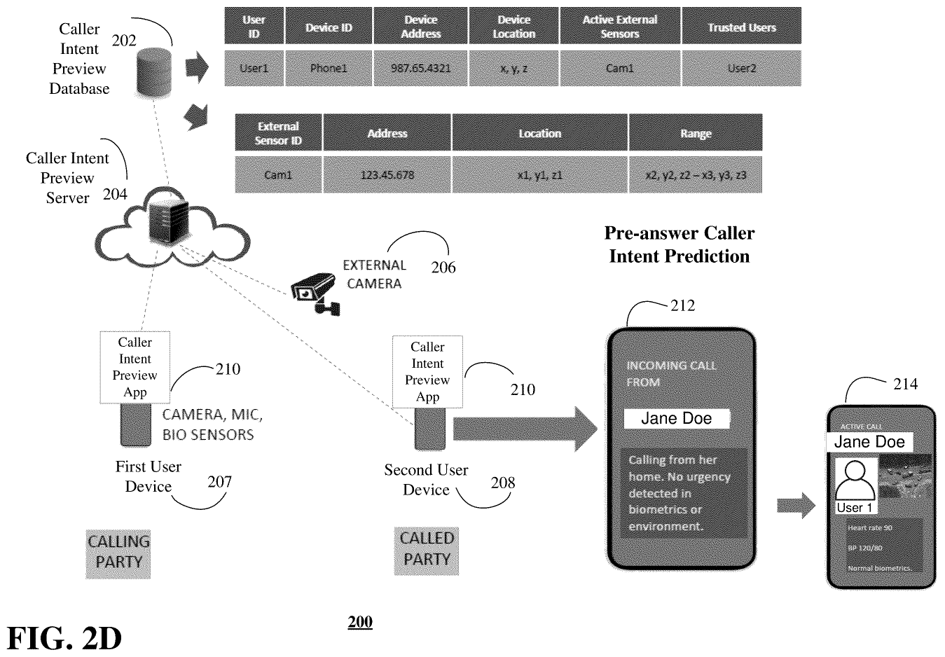

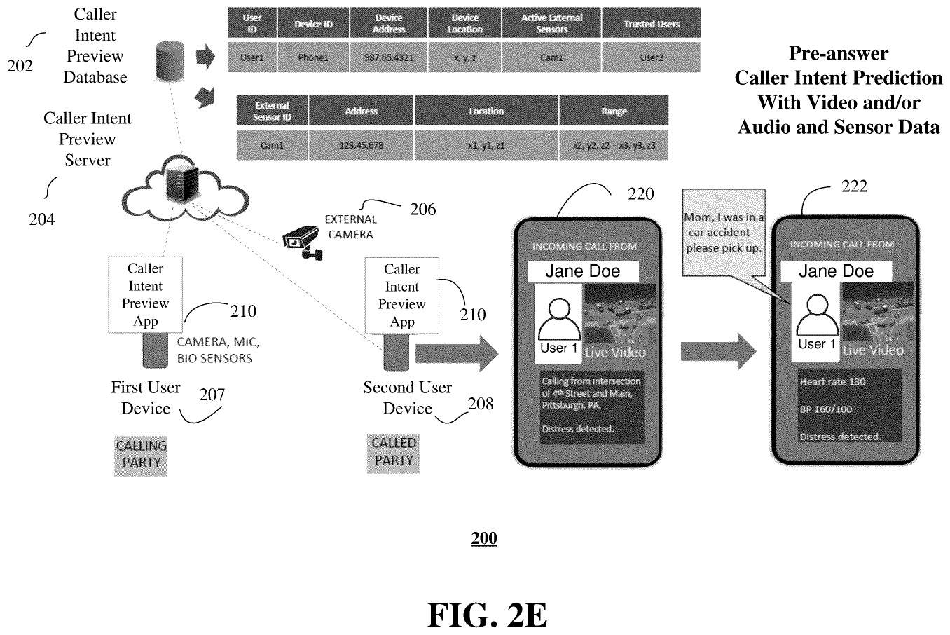

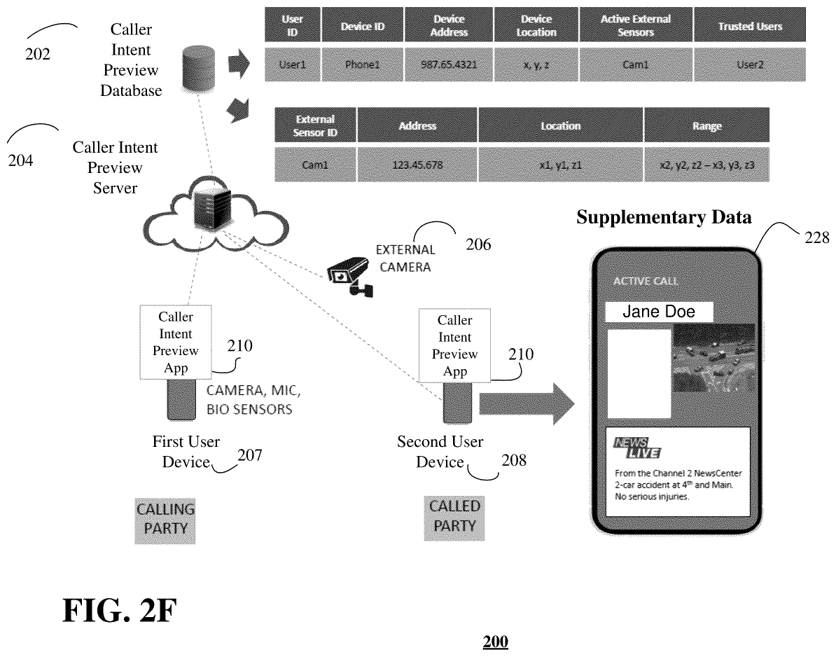

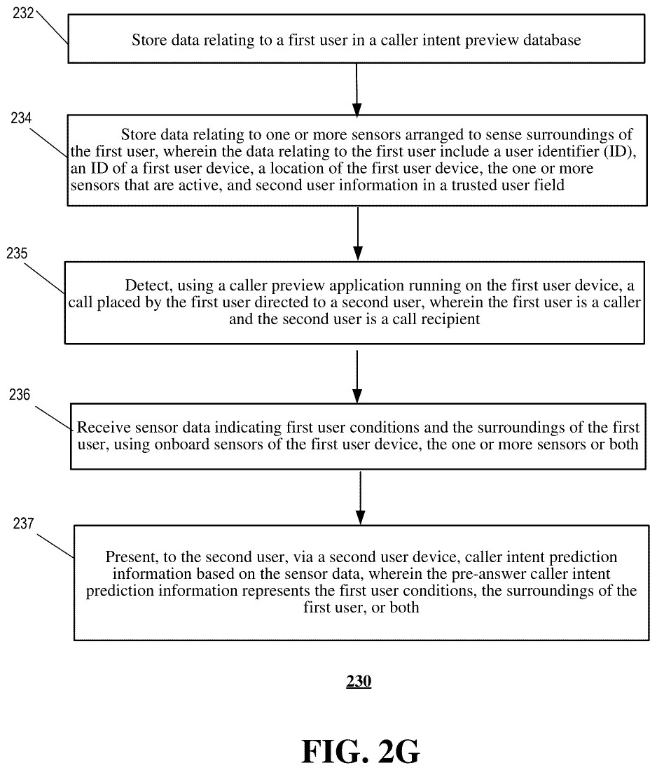

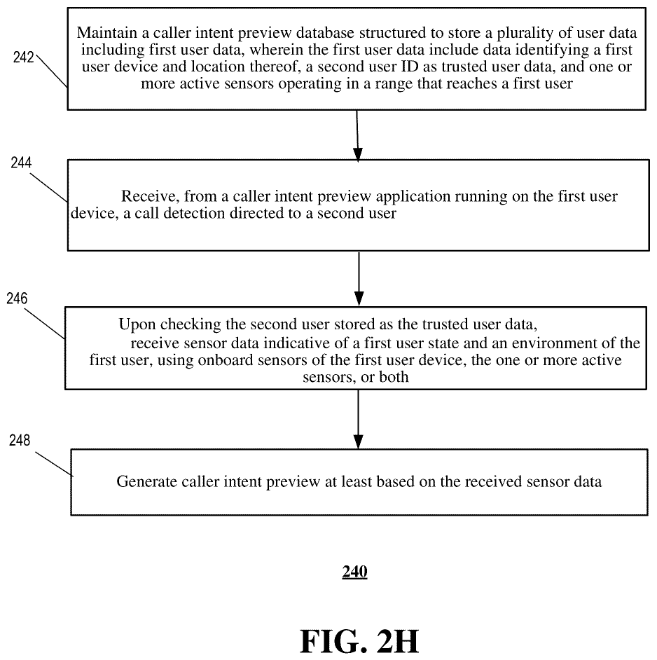

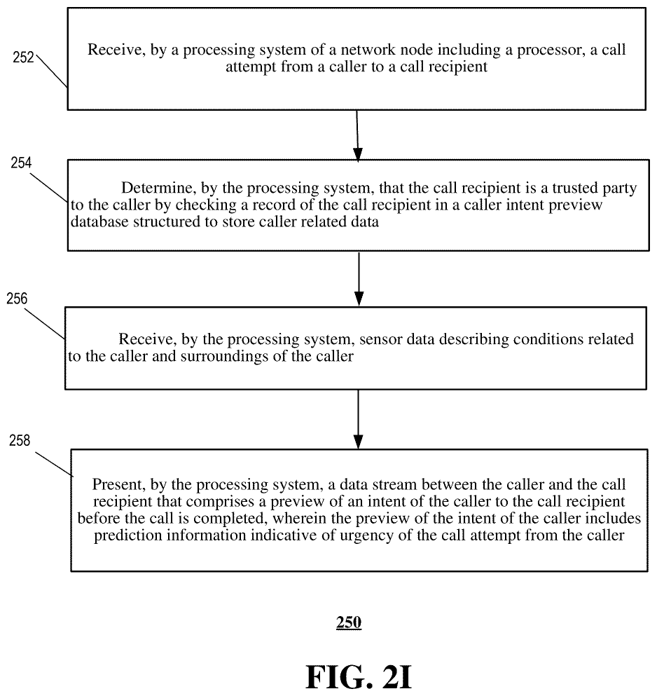

FIG. 2A is a block diagram illustrating an example, non-limiting embodiment of a system 200 functioning within the communication network of FIG. 1 in accordance with various aspects described herein.

The system 200 can include hardware and/or software (which can include virtual functionality) for providing a pre-answer caller intent preview, such as a caller intent preview database 202 and a caller intent preview server 204. As an example, the caller intent preview database 202 can be a single database or multiple databases. The caller intent preview database 202 can operate as a user database storing user information including but not limited to user ID data, user device ID data, user device location data, external sensor data, biometric ID data, physical access data, and/or communication access data. The caller intent preview database 202 can operate as a user access database storing other user information (e.g., associated with other users) including but not limited to other user ID data, other user location data, other user biometric ID data, and/or other user authorization level. The caller intent preview database 202 can operate as a user relationships access database storing relationship permission information (e.g., associated with a relationship between a caller and the other user(s) such as a call recipient) including but not limited to physical access permission, and/or communication access permission. This various data can be managed and collected through the various techniques described herein, including in real-time, near-teal-time, frequently, according to a schedule, and/or according to polling.

In various embodiments, the system 200 further includes an external camera 206. The system 200 includes a calling party, i.e., a caller using a first user device 207 and a called party, i.e., a call recipient using a second user device 208. The caller may be equipped with a wireless device, i.e., the first user device 207 that is capable of initiating a call over a network such as a wireless network. The first user device 207 may be equipped with one or more sensors that may sense and collect data describing the immediate surroundings around the first user device 207, such as a camera and a microphone. The one or more sensors may also include biometric sensors that may collect data about the caller, such as a heart rate, fingerprints, body temperature, and others.

In various embodiments, the first user device 207 may be equipped with a caller intent preview application 210 that may be in communication with the caller intent preview server 204. In one or more embodiments, the caller intent preview application 210 is implemented as software application(s) and can be resident on or accessible to (e.g., via a browser) user devices or user equipment operating in the system 200, such as the first user device 207 and the second user device 208.

The caller intent preview server 204 may also have access to the caller intent preview database 202, such as over a network. There may also exist one or more external sensors, such as the external camera 206. In other embodiments, the external sensors can be part of equipment associated with a premises, including a WLAN, a home network, a security network, a building management system, and so forth. In one or more embodiments, the caller intent preview server 204 can have access to or otherwise be in communication with various sensors for collecting information associated with user devices, as well as collecting other information that facilitates the pre-answer caller intent preview including environmental information, security information, images, audio, pressure, tactile, light, motion, temperature, and so forth. In one or more embodiments, one or more of external sensors such as the external camera 206 can be part of IoT device(s). In one or more embodiments, the caller intent preview server 204 can have access to or otherwise be in communication with various on-board sensors of user devices for collecting information associated with users, as well as collecting other information that facilitates the pre-answer caller intent preview including images, audio, location, motion, gyroscopic data and so forth. For example, the on-board sensors can be integrated with or otherwise controlled by the first user device 207 and a second user device 208.

In various embodiments, the system 200 is further configured to provide a video preview of a caller and surroundings of the caller to the call recipient before connecting the call between the caller and the call recipient. In some cases, the video preview showing the caller's surroundings may be provided. Additionally or alternatively, a predicted context of the call may be developed based on sensors in the vicinity of the caller so as to provide the call recipient with a prediction of the intent of the caller with or without the video preview.

FIG. 2B is a block diagram illustrating an example, non-limiting embodiment of a user device and sensor registrations in accordance with various aspects described herein. In various embodiments, the caller intent preview database 202 records registration information of the first user device 207 and registration information of the external sensor 206. The registration information of the first user device 207 records User ID, Device ID, Device Address, Device Location, Active External Sensors, etc. The registration information of the external sensor 206 includes External Sensor ID, an electronic address for the external sensor, a location for the external sensor, a range of operational area across which the external sensor 206 may operate, etc.

In various embodiments, the first user device 207 may register using the caller intent preview application 210 via the caller intent preview server 204 and create a record in the caller intent preview database 202 that includes a user ID and a device ID, along with the device address for the device of the caller, as depicted in FIG. 2B. The first user device 207 may also be location aware and update continually the device location in the record. The caller intent preview server 204 may continually monitor and update the location of the first user device 207 to determine if there are any external sensors that have a range of location coordinates that include the current location coordinates of the first user device 207. If so, the active external sensor may be shown in the database record as being active for the first user device 207 (e.g., “Cam 1”).

FIG. 2C is a block diagram illustrating an example, non-limiting embodiment of a user relationship registration in accordance with various aspects described herein. The first user may specify one or more other users as trusted users. In some embodiments, the first user and other users specified as the trusted users may form temporary relationships. Co-pending U.S. patent application Ser. No. 18/921,806 (having Attorney Docket No. 2023-0487_7785-3599A), entitled “METHOD AND SYSTEM FOR MULTI-PARTY TEMPORARY RELATIONSHIPS,” filed on Oct. 21, 2024, describe establishing temporary relationships between users and the disclosure of the co-pending application are incorporated by reference herein.

These trusted users and their device IDs may be stored in the database record of the caller intent preview database 202. As depicted in FIG. 2C, the first user's record stored in the caller intent preview database 202 includes a field of “Trusted Users” which identifies “User 2,” i.e., the second user. These trusted users are users for which the first user may permit a preview to the second user when a call attempt is made from the first user to the second user. These trusted users may be specified using a user interface on the first user device 207. If a call recipient is not recorded as a trusted user, the call placed by the first user may be treated as a regular phone call and may not trigger the pre-answer caller intent preview. FIG. 2C illustrates an exemplary display on the user interface, such as “Show preview video of me before call is answered when I call these contacts:” and a thumbnail image of the second user or an avatar image of the second user along with a checkmark by way of example only. Other graphical presentations in different formats are available.

FIG. 2D illustrates an example, non-limiting embodiment of a pre-answer caller intent prediction in accordance with various aspects described herein. When the first user places a call to the second user, the caller intent preview server 204 may check the caller intent preview database 202 to determine if the second user is a trusted user of the first user based on the “Trusted Users” field. Upon identification of the second user in the “Trusted Users” field, one or more sensors may be used from the first user device 207 to collect data about the first user and environment or surroundings around the first user. Additionally, the external sensor 206 may be used to collect data about the first user or the environment around the first user, if the external camera 206 is determined to be an active external camera for the first user (the “Active External Sensors” field in the caller intent preview database 202).

In various embodiments, the caller intent preview server 204 is in communication with the caller intent preview application 210 running on the first user device 207 and the second device 208, respectively. The caller intent preview application 210 is configured to detect the call placed by the first user to the second user and sends the call detection to the caller intent preview server 204. The caller intent preview application 210 is further configured to receive, process and send measurement data from onboard sensors of the first user device 207. For instance, the measurement data include biometric information of the first user at the time that the call has been placed, image files, audio files, motion data, location information, etc. The caller intent preview server 204 receives information from the caller intent preview application 210 running on the second user device 208 as to whether the second user has answered the call, whether the call is ongoing or ended, etc. Additionally, the caller intent preview server 204 receives sensor data about the second user and/or environments or surroundings of the second user. The caller intent preview server 204 can access external sensor data arranged proximate to the location of the second user if such external sensor is registered and active such that the caller intent preview server 204 can expand the scope of monitoring and sending. In other embodiments, the caller intent preview server 204 can provide information about the second user, i.e., the call recipient to the first user, the caller which helps the caller to know a reason why the call recipient does not answer the call. For instance, the second user's biometric information can be provided to the first user when the first user is registered as a trusted user by the second user in the caller review database 202.

In one or more embodiments, external sensors arranged for traffic monitoring, vehicles, security monitoring, etc. can be registered in the caller intent preview database 202 and communicate with the caller intent preview server 204. The caller intent preview server 204 may poll data from these registered external sensors based on a target location of a caller in order to obtain relevant sensor data. The external sensors may also communicate with one another via the caller intent preview server 204 and exchange data.

The caller intent preview server 204 may collect and analyze all of the sensor data, including location information, and create a preview intent message to present to the call recipient. This prediction may be made based on the data from the onboard sensors of the first user device 207 and external sensors including the external camera 206. FIG. 2D illustrates a first exemplary display 212 on a user interface of the second user device 208 which shows the caller's name, i.e., Jane Doe and “Calling from her home. No urgency detected in biometrics or environment.” As described above, the data from the onboard sensors of the first user device 207 and the external sensors provide predicted information such as the caller's location (“her home”), the caller's physical condition (“No urgency detected in biometrics . . . ”), the caller's surroundings (“No urgency detected in . . . environment.”), etc. These pieces of information about the first user who has called allow the second user to expect no emergency situation or no urgent situation of the first user. If the second user is in a situation where it is desirable to call back later, such as the second user being busy, in a meeting, in transit, etc., then the second user can make a decision to answer the call or not based on the caller intent prediction information indicative of no emergency or no urgency.

In various embodiments, the caller intent preview server 204 may utilize artificial intelligence/machine learning (AI/ML) techniques to analyze all of the sensor data, including location information and generate a preview intent message to be presented to the call recipient. Additionally or alternatively, the caller intent preview application 210 may utilize the AI/ML techniques as a part of the application or interacting with AI/ML models in analyzing sensor data from the onboard sensors of the first user device 207. For instance, the AI/ML models can be used to identify patterns in the analyzed sensor data. By way of example, the AI/ML models can be used to detect user behavior patterns or user usage patterns of the first user device 207 by the first user such as a certain time of the day associated with the first user device's location. Thus, if the first user device's location is different from a regular location at a certain time of the day, such deviation from the regular location can be provided to the caller intent preview server 204.

In various embodiments, the AI/ML techniques can be subject to training by using various sensor data or sensor measurements as input data and generating an output indicative of conditions of the first user or the first user state such as no urgency detected, no emergency detected, distress detected, unusual location, first visited location, accident detected, etc. Additionally, the caller intent preview database 202 may be configured to allow the first user to add a particular set of information relating to the first user's state such as a travelling plan, expected medical conditions, etc. in order to be used in generating the caller intent preview message.

FIG. 2D further illustrates that after the call is answered by the call recipient, i.e., the second user, a data stream may continue to exist between the first user and the second user such that other data collected from the first user device 207's sensors or external sensors may be presented to user two in connection with the ongoing call. For instance, the first user's biometric data is displayed as shown in a second exemplary display 214 in FIG. 2D, e.g., Heart rate 90, BP 120/80 and Normal biometrics. Such sensor data presentation confirms the caller intent prediction such as “No urgency detected in biometrics . . . ”

As depicted in FIG. 2D, the caller's surroundings are provided to the call recipient with a video preview which is displayed right next to a thumbnail image of the first user. A live video stream of the first user may be presented using a camera on user one's device. This camera may in one case create a live video or in another embodiment may be used to create a preview live still image. In either case, the caller intent preview server 204 may analyze the video or image and predict an emotion that may be conveyed in the call preview presentation to the second user. Additionally, other biometric sensor data may be used to predict this intent. If available, data from the external camera 206 may also be used in which case the external camera 206 may optimally be able to present to the second user an image or video of the environment around user one. Therefore, in this case, multiple live stream, video or live image, feeds may be presented in the preview presentation. The video preview may have been obtained from the external camera 206 or the onboard sensors of the first user device 207. A data stream of the video preview from the external camera 206 may also continue to be presented to the second user after the call is answered by the second user.

FIG. 2E illustrates another example, non-limiting embodiment of a pre-answer caller intent prediction in accordance with various aspects described herein. FIG. 2E illustrates a first exemplary display 220 on a user interface of the second user device 208 which shows the caller's name, i.e., Jane Doe and “Calling from intersection of 4^{th} Street and Main, Pittsburgh, PA” and “Distress detected.” As described above, the data from the onboard sensors of the first user device 207 and external sensors including the external camera 206 provide predicted information such as (“Distress detected”) along with the caller's specific location. As described above, the AI/ML techniques can be used to make a determination of the predicted information such as “Distress detected.” Furthermore, the caller's surroundings are provided to the call recipient with a video preview which is displayed right next to a thumbnail image of the first user. The video preview may have been obtained from the external camera 206 (also, other cameras such as security cameras, traffic cameras, dash cameras, etc.) or the onboard sensors of the first user device 207. The video preview includes a live stream of the surroundings of the first user. These pieces of information about the first user who has called allow the second user to recognize that an emergency situation or urgent situation may have happened to the first user. Even if the second user is in a situation where it is desirable to call back later, such as the second user being busy, in a meeting, in transit, etc., then the second user can make a decision to answer the call based on the caller intent prediction information indicative of potential emergency or urgency. This also will allow the second user to make a call to first responders, doctors, relatives, friends, etc. to assist the first user as needed.

FIG. 2E further illustrates that after the call is answered by the call recipient, i.e., the second user, a data stream may continue to exist between the first user and the second user such that other data collected from the first user device 207's sensors or external sensors may be presented to user two in connection with the ongoing call. For instance, the first user's biometric data is displayed as shown in a second exemplary display 222 in FIG. 2E, e.g., Heart rate 130, BP 160/100 and Distress detected. Such sensor data presentation confirms the caller intent prediction such as “Distress detected.”

As depicted in FIG. 2E, the caller's surroundings are provided to the call recipient with a video preview which is displayed right next to a thumbnail image of the first user. The video preview may have been obtained from the external camera 206 or the onboard sensors of the first user device 207. A data stream of the video preview from the external camera 206 may also continue to be presented to the second user after the call is answered by the second user.

Additionally, or alternatively, the live stream video may also include audio such that the caller may present a preview audio and video message to the call recipient before the call connection is made. This is accomplished, since the two device addresses are known and the caller intent preview server 204 may use them to create a video stream from the first user to the second user. As depicted in FIG. 2E, an audio message can be displayed in a third exemplary display 222 such as “Mom, I was in a car accident—please pick up.” The third exemplary display 222 further includes sensor data of the first user and the video preview of the first user's surroundings showing the intersection of the first user's location. Based on the audio message and the video preview along with the sensor data of the first user which shows elevated biometric conditions, the second user will receive a clear indication of urgency of the call by the first user and will highly likely answer the call.

FIG. 2F is a block diagram illustrating an example, non-limiting embodiment of an association context in accordance with various aspects described herein. Supplementary data from another source that may be relevant to the environment of the first user may also be presented to the second user. FIG. 2F illustrates an exemplary display 228 which shows supplementary data. For example, data from a news source that is location relevant and has a location tag associated with the location may be pulled in real time, so as to present additional supplementary data information to the second user about events that may be occurring at the location of the first user. For instance, when the first user is located near the emergency event and security of the first user is at risk, the first user may not have access to an ongoing state of the emergency event. The supplementary data such as news clips, messages from emergency authorities, etc. can provide helpful information for the first user and enhance security of the first user.

FIG. 2G depicts an illustrative embodiment of a method 230 in accordance with various aspects described herein. In various embodiments, the method 230 includes storing data relating to a first user in a caller intent preview database (Step 232), and storing data relating to one or more sensors arranged to sense surroundings of a first user (Step 234). The data relating to the first user include a user identifier (ID), an ID of a first user device, a location of the first user device, the one or more sensors that are active, and second user information in a trusted user field. The method 230 further includes detecting, using a caller intent preview application running on the first user device, a call placed by the first user directed to a second user, where the first user is a caller and the second user is a call recipient (Step 235), receiving sensor data indicating first user conditions and the surroundings of the first user, using onboard sensors of the first user device, the one or more sensors or both (Step 236), and presenting, to the second user, via a second user device, caller intent prediction information based on the sensor data, where the caller intent prediction information represents the first user conditions, the surroundings of the first user or both (Step 237).

In various embodiments, the method 230 further includes generating a data stream of a video showing the surroundings of the first user based on the received sensor data and presenting a preview of the video to the second user substantially simultaneously with the presentation of the caller intent prediction information. The presenting caller intent prediction information (Step 237) further includes presenting the caller intent prediction information in a text message form based on the sensor data indicating the first user conditions and the surroundings of the first user and the location of the first user device. The method 230 further includes detecting that the call placed by the first user device is connected to the second user device, and after detecting that the call is answered by the second user, maintaining the data stream of video showing the surroundings of the first user to the second user device.

In various embodiments, the method 230 further includes detecting that the call placed by the first user device is connected to the second user device, and after detecting that the call is answered by the second user, presenting an audio message of the first user in a text form on a user interface of the first user device or alternatively playing the audio message of the first user in an audible sound. The method 230 further includes detecting that the call placed by the first user device is connected to the second user device, and after the call is answered by the second user, presenting the sensor data indicative of the first user conditions, where the first user conditions include biometric information of the first user at the time of the call placed by the first user. The method 230 further includes detecting that the call placed by the first user device is connected to the second user device, and after the call is answered by the second user, presenting supplementary data from another source other than the sensor data, where the supplementary data are related to at least the location of the first user device.

FIG. 2H depicts an illustrative embodiment of another method 240 in accordance with various aspects described herein. In various embodiments, the method 240 includes maintaining a caller intent preview database structured to store a plurality of user data including first user data, where the first user data include data identifying a first user device and location thereof, a second user ID as trusted user data, and one or more active sensors operating in a range that reaches a first user (Step 242), receiving, from a caller intent preview application running on the first user device, a call detection directed to a second user (Step 244), upon checking the second user stored as the trusted user data, receiving sensor data indicative of a first user state and an environment of the first user, using onboard sensors of the first user device, the one or more active sensors, or both (Step 246), and generating caller intent preview at least based on the received sensor data (Step 248).

In various embodiments, the method 240 further includes presenting the caller intent preview and a video preview showing the environment of the first user based on the location of the first user device to the caller intent preview application running on a second user device of the second user. The method 240 further includes presenting the caller intent preview including textual prediction information about the detected call to the caller intent preview application running on a second user device of the second user. The textual prediction information about the detected call comprises a set of information indicative of urgency of the detected call, where the set of information includes at least a location of the first user device and biometric information of the first user, based on the sensor data indicative of the first user state and the environment of the first user. The method 240 further includes presenting a video preview about the environment of the first user for display on an user interface of the second user device. The method 240 further includes, after and while answering the detected call by the second user, transmitting a continuous data stream of a video about the environment of the first user to the second user device, transmitting an audio file including a message of the first user for play by the second user device, and transmitting the sensor data indicative of the first user state for display on the user interface of the second user device.

FIG. 2I depicts an illustrative embodiment of yet another method 250 in accordance with various aspects described herein. In various embodiments, the method 250 includes receiving, by a processing system of a network node including a processor, a call attempt from a caller to a call recipient (Step 252); determining, by the processing system, that the call recipient is a trusted party to the caller by checking a record of the call recipient in a caller intent preview database structured to store caller related data (Step 254); receiving, by the processing system, sensor data describing conditions related to the caller and surroundings of the caller (Step 256); and presenting, by the processing system, a data stream between the caller and the call recipient that comprises a preview of an intent of the caller to the call recipient before the call is completed, where the preview of the intent of the caller includes prediction information indicative of urgency of the call attempt from the caller (Step 258).

In various embodiments, the presenting the data stream (Step 258) further comprises presenting, to a call recipient device, the preview of the intent of the caller in a text form, a video form, an audio form or a combination thereof. The presenting the data stream (Step 258) further comprises presenting to a call recipient device, supplementary data relating to the caller, the surroundings of the caller, or both, from another source other than the sensor data. The method 250 further includes maintaining, by the processing system, the data stream after the call is completed, thereby enabling the call recipient to continue to monitor the conditions related to the caller and the surroundings of the caller.

In various embodiments, the method 250 further includes communicating, by the processing system, with a respective caller intent preview application resident on a caller device and a call recipient device, and storing, by the processing system, in a caller intent preview database, the caller related data include a user identifier (ID), an ID of the caller device, a location of the caller device, one or more external sensors that are active and covering the caller, and the call recipient in a trusted user field. The receiving sensor data (Step 256) further comprises receiving the sensor data detected by onboard sensors of the caller device, using the call preview application resident on the caller device. The presenting the data stream (Step 258) further comprises presenting the data stream to the call recipient device using the caller intent preview application resident on the call recipient device. The method 250 includes registering, by the processing system, in the caller intent preview database, one or more external sensors. The receiving sensor data describing conditions related to the caller and surroundings of the caller further comprises receiving the sensor data from the registered one or more external sensors that are indicated as being active in the caller intent preview database. The method 250 further includes generating, by the processing system, the preview of the intent of the caller by analyzing the sensor data describing conditions related to the caller and surroundings of the caller, identifying one or more patterns of the analyzed sensor data, and formulating a resulting state of the caller.

While for purposes of simplicity of explanation, the respective processes are shown and described as a series of blocks in FIGS. 2G through 2I, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

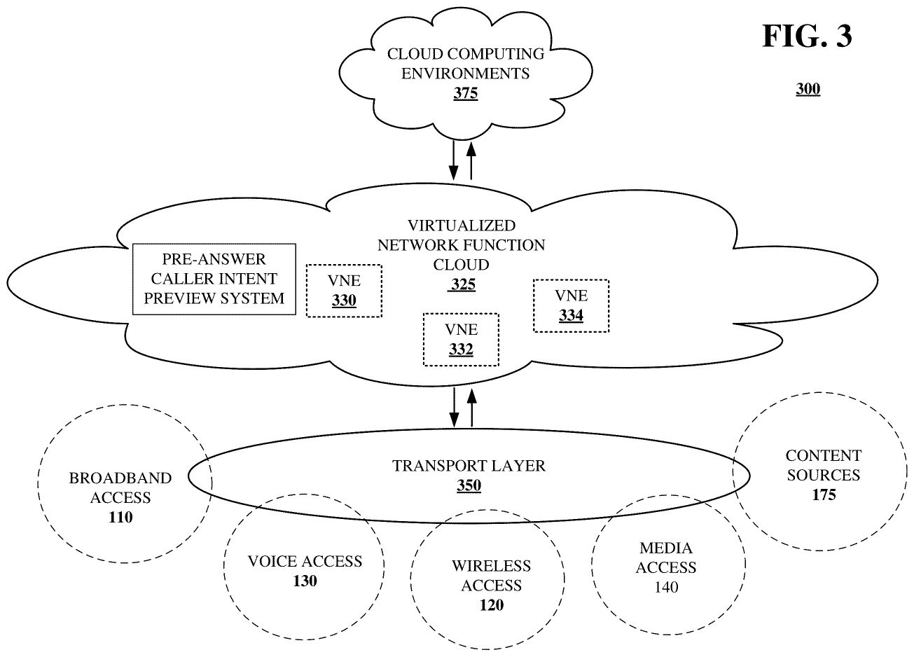

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230, 240 and 250 presented in FIGS. 1, 2B through 2F, 2G through 2I, and 3. For example, virtualized communication network 300 can facilitate in whole or in part pre-answer caller intent preview systems and methods.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers - each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

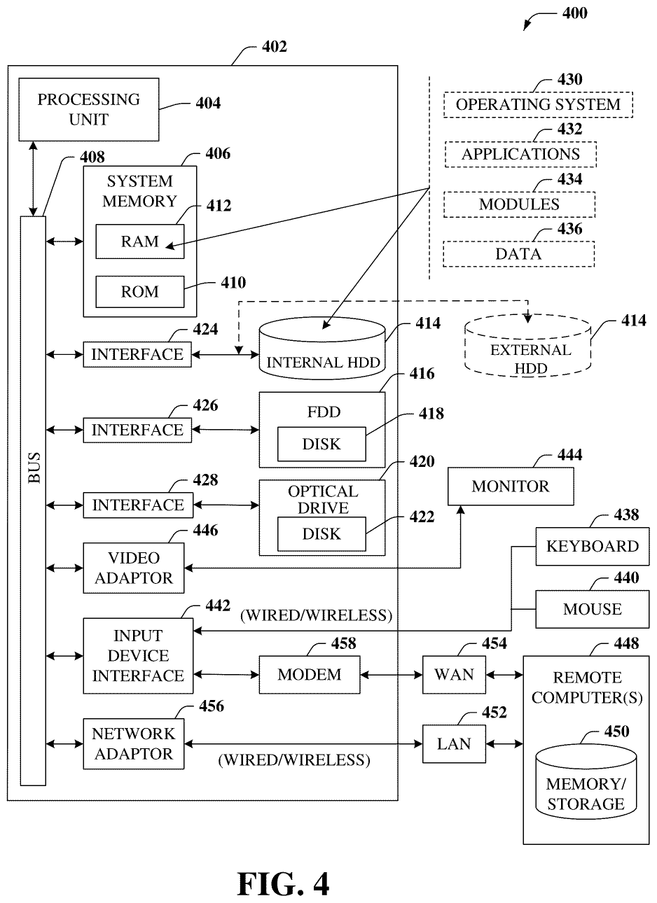

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part pre-answer caller intent preview systems and methods.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

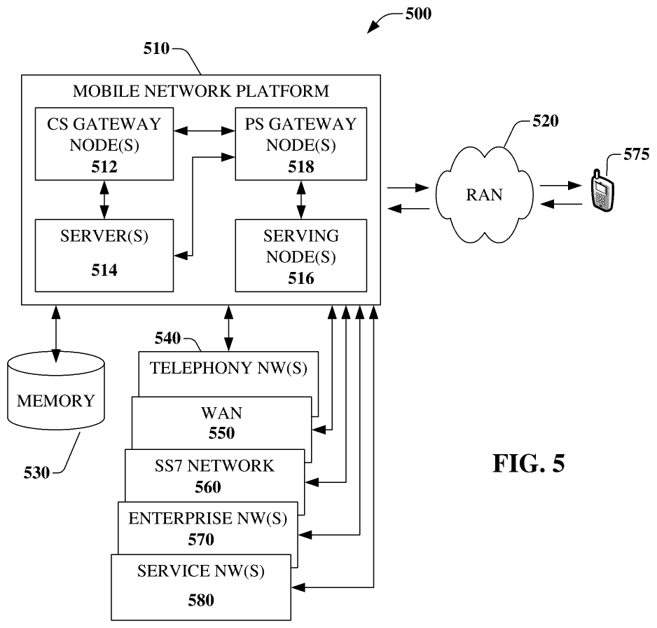

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part pre-answer caller intent preview systems and methods. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

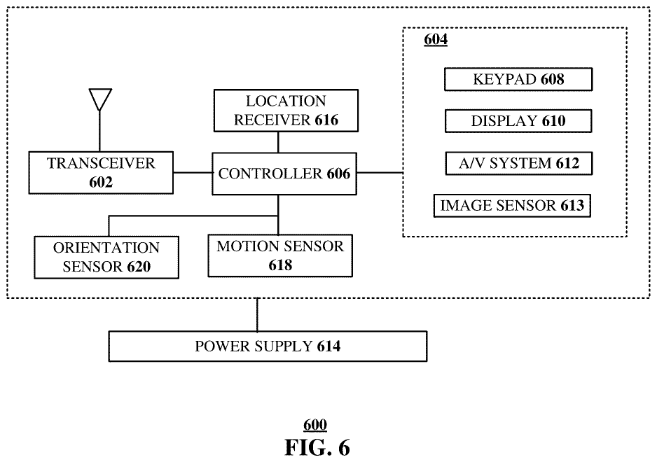

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part pre-answer caller intent preview systems and methods.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x) =confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

One or more of the embodiments described herein can be combined in whole or in part with the embodiments described in co-pending U.S. patent application Ser. No. 18/921,806 (having Attorney Docket No. 2023-0487_7785-3599A), entitled “METHOD AND SYSTEM FOR MULTI-PARTY TEMPORARY RELATIONSHIPS,” filed on Oct. 21, 2024. For instance, embodiments of one or more of the aforementioned U.S. application can be combined in whole or in part with embodiments of the subject disclosure. For example, one or more features and/or embodiments described in one or more of the aforementioned U.S. application can be used in conjunction with (or as a substitute for) one or more features and/or embodiments described herein, and vice versa. Accordingly, all sections of each of the aforementioned U.S. application are incorporated herein by reference in their entirety.

What is claimed is:

1. A device, comprising:
a processing system including a processor; and
a memory that stores executable instructions that, when executed by the processing system, facilitate performance of operations, the operations comprising:
storing data relating to a first user in a caller intent preview database;
storing data relating to one or more sensors arranged to sense surroundings of the first user,
wherein the data relating to the first user include a user identifier (ID), an ID of a first user device, a location of the first user device, the one or more sensors that are active, and second user information in a trusted user field;
detecting, using a caller intent preview application running on the first user device, a call placed by the first user directed to a second user, wherein the first user is a caller and the second user is a call recipient;
receiving sensor data indicating first user conditions and the surroundings of the first user, using onboard sensors of the first user device, the one or more sensors, or both; and
presenting, to the second user, via a second user device, caller intent prediction information based on the sensor data, wherein the caller intent prediction information represents the first user conditions, the surroundings of the first user, or both.

2. The device of claim 1, wherein the operations further comprise:
generating a data stream of a video showing the surroundings of the first user based on the received sensor data; and
presenting a preview of the video to the second user substantially simultaneously with the presentation of the caller intent prediction information.

3. The device of claim 1, wherein the presenting caller intent prediction information further comprises presenting the caller intent prediction information in a text message form based on the sensor data indicating the first user conditions and the surroundings of the first user and the location of the first user device.

4. The device of claim 2, wherein the operations further comprise:
detecting that the call placed by the first user device is connected to the second user device; and
after detecting that the call is answered by the second user, maintaining the data stream of video showing the surroundings of the first user to the second user device.

5. The device of claim 1, wherein the operations further comprise:
detecting that the call placed by the first user device is connected to the second user device; and
after detecting that the call is answered by the second user, presenting an audio message of the first user in a text form on a user interface of the first user device or alternatively playing the audio message of the first user in an audible sound.

6. The device of claim 1, wherein the operations further comprise:
detecting that the call placed by the first user device is connected to the second user device; and
after the call is answered by the second user, presenting the sensor data indicative of the first user conditions, wherein the first user conditions include biometric information of the first user at the time of the call placed by the first user.

7. The device of claim 1, wherein the operations further comprise:
detecting that the call placed by the first user device is connected to the second user device; and
after the call is answered by the second user, presenting supplementary data from another source other than the sensor data, wherein the supplementary data are related to at least the location of the first user device.

8. A machine-readable medium, comprising executable instructions that, when executed by a processing system including a processor, facilitate performance of operations, the operations comprising:
maintaining a caller intent preview database structured to store a plurality of user data including first user data, wherein the first user data include data identifying a first user device and location thereof, a second user ID as trusted user data, and one or more active sensors operating in a range that reaches a first user;
receiving, from a caller intent preview application running on the first user device, a call detection directed to a second user;
upon checking the second user stored as the trusted user data,
receiving sensor data indicative of a first user state and an environment of the first user, using onboard sensors of the first user device, the one or more active sensors, or both; and
generating caller intent preview at least based on the received sensor data.

9. The machine-readable medium of claim 8, wherein the operations further comprise:
presenting the caller intent preview and a video preview showing the environment of the first user based on the location of the first user device to the caller intent preview application running on a second user device of the second user.

10. The machine-readable medium of claim 8, wherein the operations further comprise:
presenting the caller intent preview including textual prediction information about the detected call to the caller intent preview application running on a second user device of the second user.

11. The machine-readable medium of claim 10, wherein the textual prediction information about the detected call comprises a set of information indicative of urgency of the detected call, wherein the set of information includes at least a location of the first user device and biometric information of the first user, based on the sensor data indicative of the first user state and the environment of the first user.

12. The machine-readable medium of claim 10, wherein the operations further comprise presenting a video preview about the environment of the first user for display on an user interface of the second user device.

13. The machine-readable medium of claim 12, wherein the operations further comprise after and while answering the detected call by the second user:
transmitting a continuous data stream of a video about the environment of the first user to the second user device;
transmitting an audio file including a message of the first user for play by the second user device; and
transmitting the sensor data indicative of the first user state for display on the user interface of the second user device.

14. A method, comprising:
receiving, by a processing system of a network node including a processor, a call attempt from a caller to a call recipient;
determining, by the processing system, that the call recipient is a trusted party to the caller by checking a record of the call recipient in a caller intent preview database structured to store caller related data;
receiving, by the processing system, sensor data describing conditions related to the caller and surroundings of the caller; and
presenting, by the processing system, a data stream between the caller and the call recipient that comprises a preview of an intent of the caller to the call recipient before a call is completed, wherein the preview of the intent of the caller includes prediction information indicative of urgency of the call attempt from the caller.

15. The method of claim 14, wherein the presenting the data stream further comprises presenting, to a call recipient device, the preview of the intent of the caller in a text form, a video form, an audio form or a combination thereof.

16. The method of claim 14, wherein the presenting the data stream further comprises presenting to a call recipient device, supplementary data relating to the caller, the surroundings of the caller, or both, from another source other than the sensor data.

17. The method of claim 14, further comprising maintaining, by the processing system, the data stream after the call is completed, thereby enabling the call recipient to continue to monitor the conditions related to the caller and the surroundings of the caller.

18. The method of claim 14, comprising:
communicating, by the processing system, with a respective caller intent preview application resident on a caller device and a call recipient device; and
storing, by the processing system, in a caller intent preview database, the caller related data include a user identifier (ID), an ID of the caller device, a location of the caller device, one or more external sensors that are active and covering the caller, and the call recipient in a trusted user field; and
wherein the receiving sensor data further comprises receiving the sensor data detected by onboard sensors of the caller device, using the caller intent preview application resident on the caller device; and
the presenting the data stream further comprises presenting the data stream to the call recipient device using the caller intent preview application resident on the call recipient device.

19. The method of claim 18, comprising:
registering, by the processing system, in the caller intent preview database, one or more external sensors; and
wherein the receiving sensor data describing conditions related to the caller and surroundings of the caller further comprises receiving the sensor data from the registered one or more external sensors that are indicated as being active in the caller intent preview database.

20. The method of claim 14, comprising:
generating, by the processing system, the preview of the intent of the caller by analyzing the sensor data describing conditions related to the caller and surroundings of the caller, identifying one or more patterns of the analyzed sensor data, and formulating a resulting state of the caller.
